(19) United States
(12) Patent Application Publication
(10) Pub. No.: US 2002/0105194 A1
(43) Pub. Date: Aug. 8, 2002

(54) Limit piece and fixing plate structure of lock

(75) Inventor: Kuo-Jui Huang, Kaohsiung Hsien (TW)

Correspondence Address: Bacon & Thomas, 4th Floor, 625 Slaters Lane, Alexandria, VA, 22314, US

(73) Assignee: Taiwan Fu Hsing Industrial Co., Ltd., Kaohsiung Hsien (TW)

(21) Appl. No.: 09/776,901

(22) Filed: Feb. 6, 2001

(51) Int. Cl. E05B 3/00

(52) U.S. Cl. 292/347

(57) ABSTRACT

A limit piece and fixing plate structure of a lock includes a limit piece defining a drive hole which is driven by a drive plate, so that a short side thereof may be extended into the notch of the fixing plate. The short side defines a recess in which the lug formed on the bottom of the notch of the fixing plate may be locked, thereby forming a double lock effect between the limit piece and the fixing plate.

### BACKGROUND OF THE INVENTION

1. Field of the Invention

The present invention relates to a limit piece and fixing plate structure of a lock, and more particularly to a limit piece and fixing plate structure of a lock, wherein the limit piece and the fixing plate have a better locking strength, for supporting a larger breaking torque.

2. Description of the Related Prior Art

The closest prior art of which the applicant is aware is disclosed in his Taiwanese Patent Publication No. 275902, entitled by “Cylindrical Lock Structure” which includes a rotation knob 11 drives a drive plate 47 to lift and lower a limit plate 35 which is locked in a bottom plane 55 between annular walls 54 of a fixing plate 5, thereby controlling rotation of a handle 2.

The lock is locked by means of the limit plate 35 entering the bottom plane 55 between the annular walls 54 of the fixing plate 5, while movement of the limit plate 35 is driven by means of the rotation knob 11 driving the drive plate 47 to rotate. Thus, the range of lift and lower of the limit plate 35 is limited. Therefore, the locked lock may support a breaking torque (from rotation of the handle 2) by means by the limit plate 35 locked between the annular walls 54 of the fixing plate 5. The fixing plate 5 does not have a large protrusion during the machining process, and the fixing plate 5 has arc-shaped angles. Therefore, when the handle (especially a flat handle) exerts a force, the limit plate 35 will slip and detach from the breach position between the annular walls 54, so that the lock is unlocked by the breaking force. Thus, a person can illegally apply a larger external force to press the handle, so that the limit plate 35 will slip and detach from the breach position between the annular walls 54 of the fixing plate 5, thereby achieving the breaking purpose of unlocking the lock.

### SUMMARY OF THE INVENTION

The primary objective of the present invention is to provide a limit piece and fixing plate structure of a lock, wherein after the limit piece and the fixing plate are assembled, the lock can be adapted to support a larger torque, thereby resisting the breaking strength from an external rotational force.

In accordance with the present invention, there is provided a limit piece and fixing plate structure of a lock includes a limit piece defining a drive hole which is driven by a drive plate, so that a short side thereof may be extended into the notch of the fixing plate. The short side defines a recess in which the lug formed on the bottom of the notch of the fixing plate may be locked, thereby forming a double lock effect between the limit piece and the fixing plate, so that the lock can be adapted to support and bear a larger torque without being broken.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a limit piece and fixing plate structure of a lock in accordance with the present invention;

FIG. 2 is an exploded perspective view of the limit piece and fixing plate structure of a lock as shown in FIG. 1 which is assembled with an entire handle structure;

FIG. 3 is a cross-sectional assembly view of the limit piece and fixing plate structure of a lock as shown in FIG. 2, wherein the lock is unlocked; and

FIG. 4 is a schematic operational view of the limit piece and fixing plate structure of a lock as shown in FIG. 3, wherein the lock is locked.

### DETAILED DESCRIPTION OF THE PREFERRED EMBODIMENTS

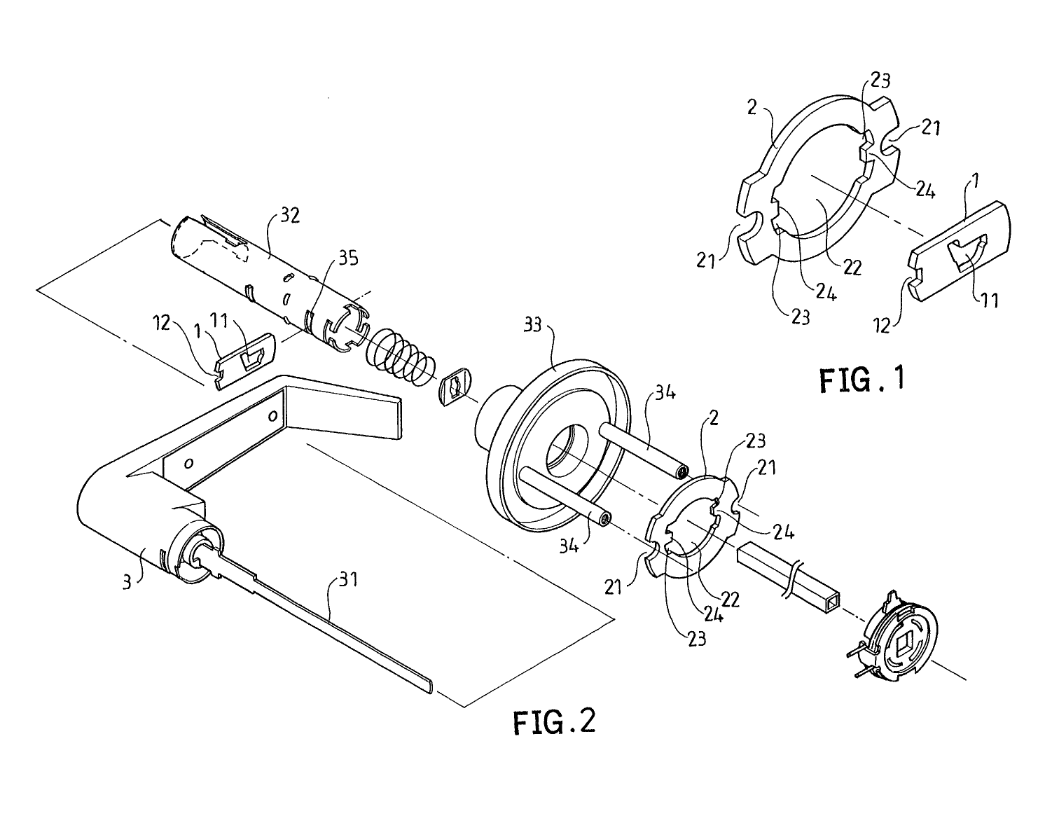

Referring to the drawings and initially to FIGS. 1 and 2, a limit piece and fixing plate structure of a lock in accordance with the present invention comprises a limit piece 1, and a fixing plate 2.

The limit piece 1 has a longitudinal elongated shape, and has a central position defining a drive hole 11, for allowing passage of a drive plate 31, for driving the limit piece 1 to linearly move in an axial tube 32. The limit piece 1 has a short side extending toward a longitudinal elongated direction thereof and defining a recess 12.

The fixing plate 2 defines positioning holes 21 for allowing passage posts 34 of a cover 33, so that the fixing plate 2 is secured on the cover 33, and cannot be rotated relative to the cover 33. The fixing plate 2 defines an axial hole 22 for allowing passage and rotation of the axial tube 32. The maximum length of the limit piece 1 is smaller than the diameter of the axial hoe 22, so that the limit piece 1 may be rotated in the axial hole 22 during the normal state. The axial hole 22 has a periphery defining at least one notch 23. As shown in figures, it is appropriate that the fixing plate 2 includes two notches 23 located on two symmetrical positions. The notches 23 allow enter and insertion of the two short sides of the limit piece 1, thereby forming a first lock action. In addition, the notch 23 has a bottom provided with a protruding lug 24, so that when the limit piece 1 is driven by the drive plate 31 to enter the notch 23 of the fixing plate 2, the lug 24 of the fixing plate 2 may be extended into the recess 12 of the limit piece 1, thereby forming a second lock action.

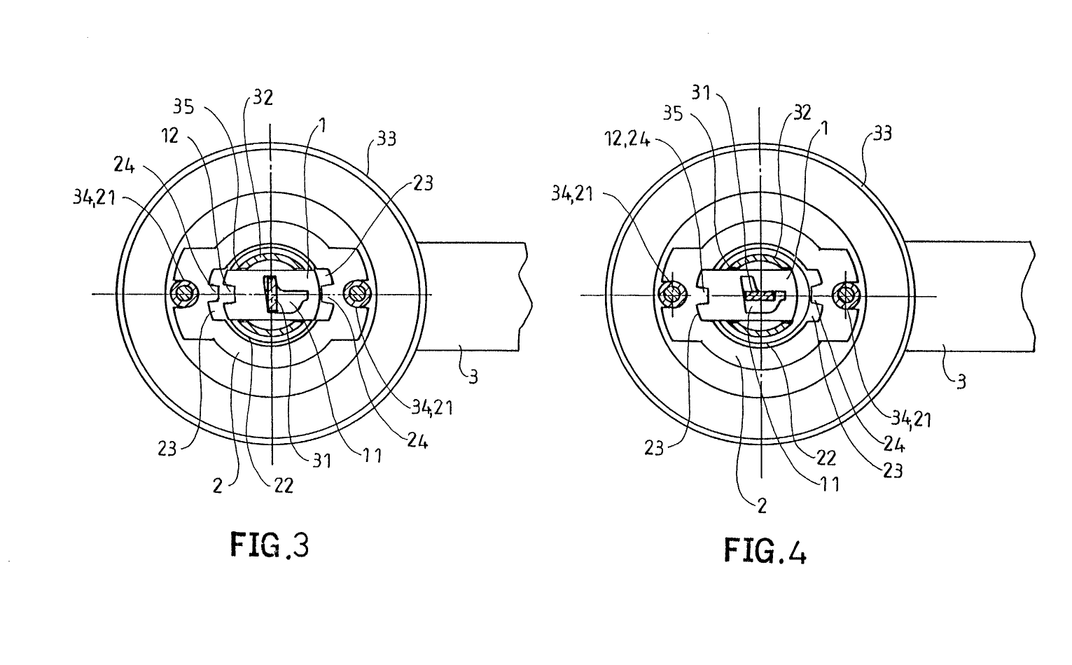

Referring to FIGS. 2 and 3, in accordance with the present invention, the limit piece 1 is fitted in the locking hole 35 of the axial tube 32, while the drive plate 31 passes through the drive hole 11. When the lock is unlocked, the limit piece 1 is hidden into the axial hole 22 of the fixing plate 2, so that the handle 3 can drive the axial tube 32 to rotate.

Referring to FIG. 4, when the drive plate 31 is rotated, the drive plate 31 may force the limit piece 1 to move, whereby the short side of the limit piece 1 is extended into the notch 23 of the fixing plate 2, while the lug 24 of the fixing plate 2 may be extended into the recess 12 of the limit piece 1, thereby forming a double lock effect between the limit piece 1 and the fixing plate 2.

Accordingly, in accordance with the construction of the present invention, a double lock effect is formed between the limit piece and the fixing plate, so that when the limit piece is locked with the fixing plate, the lock can be adapted to support and bear the breaking force of a larger torque, thereby preventing a person illegally breaking the lock in a strongly rotational manner.

Although the invention has been explained in relation to its preferred embodiment as mentioned above, it is to be understood that many other possible modifications and variations can be made without departing from the scope of the present invention. It is, therefore, contemplated that the appended claims will cover such modifications and variations that fall within the true scope of the invention.

What is claimed is:

1. A limit piece and fixing plate structure of a lock, comprising:
a limit piece, having a longitudinal elongated shape, having a center defining a drive hole, the limit piece having a short side extending toward a longitudinal elongated direction and defining a recess; and
a fixing plate, defining positioning holes secured on a cover, the fixing plate defining an axial hole for allowing passage and rotation of an axial tube, the axial hole having a periphery defining at least one notch, the at least one notch having a bottom provided with a protruding lug;
wherein, the limit piece may be driven, so that a short side thereof is extended into the at least one notch of the fixing plate, and the lug of the fixing plate may be extended into the recess of the limit piece, thereby forming a double lock effect between the limit piece and the fixing plate.

2. The limit piece and fixing plate structure of a lock as claimed in claim 1, wherein the fixing plate includes notches located on two symmetrical positions.
